(19) United States
(12) Patent Application Publication
(10) Pub. No.: US 2026/0141545 A1
(43) Pub. Date: May 21, 2026

(54) INFRARED ASSISTED OBJECT SEGMENTATION AND RANGE PERCEPTION FOR VEHICLE ENVIRONMENTAL MODELS

(71) Applicant: FCA US LLC, Auburn Hills, MI (US)

(72) Inventors: Daniel Cashen, Auburn Hills, MI (US); Emily A Robb, Auburn Hills, MI (US)

(21) Appl. No.: 18/950,658

(22) Filed: Nov. 18, 2024

(51) Int. Cl. G06T 7/50; G01S 13/86; G06T 7/11; G06T 7/168; G06T 17/00

(52) U.S. Cl. CPC G06T 7/50; G01S 13/867; G06T 7/11; G06T 7/168; G06T 17/00; G06T 2207/10024; G06T 2207/10028; G06T 2207/10048; G06T 2207/20061; G06T 2207/30256

(57) ABSTRACT

An infrared (IR) assisted object segmentation and range perception system and method for a vehicle each utilize a camera system configured to capture image data of an environment external to the vehicle, the image data including unfiltered IR data, and a control system configured to generate an environmental model for the environment external to the vehicle by (i) performing object segmentation of one or more objects in the captured image data based on the unfiltered IR data and (ii) based on the object segmentation, perform range perception of the one or more objects, and utilize the generated environmental model during operation of the vehicle.

### FIELD

The present application generally relates to vehicle perception systems and, more particularly, to techniques for infrared (IR) assisted object segmentation and range perception for vehicle environmental models.

### BACKGROUND

Vehicle perception systems use visual data, captured by a camera system, and range data to build an environmental model (i.e., of the area surrounding the vehicle). Higher end vehicles utilize light detection and ranging (LIDAR) for precise range measurement, but LIDAR is very expensive. Camera-based depth or range perception is also prone to error as it is not a direct measurement. An alternative solution is to utilize radio detection and ranging (RADAR) for range detection. RADAR, however, is inherently noisy, particularly due to ground reflections. Fusion of camera and RADAR data is also difficult as it can be unclear which data point is correct. Additionally, while RADAR may not have a significant impact on the accuracy of a camera-based environmental modeling, it does provide redundancy that could prevent a camera malfunction scenario that could result in a vehicle collision or crash. Accordingly, while such conventional vehicle depth or range perception systems do work for their intended purpose, there exists an opportunity for improvement in the relevant art.

### SUMMARY

According to one example aspect of the invention, an infrared (IR) assisted object segmentation and range perception system for a vehicle is presented. In one exemplary implementation, the IR assisted object segmentation and range perception system comprises a camera system configured to capture image data of an environment external to the vehicle, the image data including unfiltered IR data, and a control system configured to generate an environmental model for the environment external to the vehicle by (i) performing object segmentation of one or more objects in the captured image data based on the unfiltered IR data and (ii) based on the object segmentation, perform range perception of the one or more objects, and utilize the generated environmental model during operation of the vehicle.

In some implementations, the camera system is further configured to apply a color filter array (CFA) to at least a portion of the image data to obtain filtered color data that is part of the captured image data. In some implementations, the control system is configured to perform the object segmentation of the one or more objects based further on a combination of the unfiltered IR data and the filtered color data. In some implementations, the control system is further configured to determine a transform of the unfiltered IR data and the filtered color data, based on a gradient of the determined transform, detect missing object segmentation data that is not present in the filtered color data, and perform the object segmentation based on the detected missing object segmentation data. In some implementations, the transform is a Hough transform. In some implementations, the missing object segmentation data is a lane marking having a luminance that is substantially equal to a luminance of a road edge.

In some implementations, the camera system is a color type camera system that does not include an IR filter. In some implementations, the camera system is a color-IR type camera system where the CFA and a light sensor are associated with only a portion of a plurality of pixels and at least some of the plurality of pixels are associated with an IR sensor. In some implementations, the CFA is a red/green/blue (RGB) type CFA having red, green, and blue pixels associated with every three pixels of the plurality of pixels, and wherein the IR sensor is a passive IR sensor and every fourth pixel of the plurality of pixels are associated with the IR sensor and not the CFA. In some implementations, the IR assisted object segmentation and range perception system further comprises a radio detection and ranging (RADAR) system of the vehicle, wherein the RADAR system is configured to capture RADAR data of the environment external to the vehicle, and wherein the control system configured to generate the environmental model further by (iii) fusing the range perception of the one or more objects based on the object segmentation with range perception based on the RADAR data.

According to another example aspect of the invention, an IR assisted object segmentation and range perception method for a vehicle is presented. In one exemplary implementation, the IR assisted object segmentation and range perception method comprises capturing, by a camera system of the vehicle, image data of an environment external to the vehicle, the image data including unfiltered IR data, receiving, by a control system of the vehicle and from the camera system, the RADAR data and the image data, generating, by the control system, an environmental model for the environment external to the vehicle by (i) performing object segmentation of one or more objects in the captured image data based on the unfiltered IR data and (ii) based on the object segmentation, perform range perception of the one or more objects, and utilizing, by the control system, the generated environmental model during operation of the vehicle.

In some implementations, the IR assisted object segmentation and range perception method further comprises applying, by the camera system, a CFA to at least a portion of the image data to obtain filtered color data that is part of the captured image data. In some implementations, the performing of the object segmentation of the one or more objects is based further on a combination of the unfiltered IR data and the filtered color data. In some implementations, the IR assisted object segmentation and range perception method further comprises determining, by the control system, a transform of the unfiltered IR data and the filtered color data, based on a gradient of the determined transform, detecting, by the control system, missing object segmentation data that is not present in the filtered color data, and performing, by the control system, the object segmentation based on the detected missing object segmentation data. In some implementations, the transform is a Hough transform. In some implementations, the missing object segmentation data is a lane marking having a luminance that is substantially equal to a luminance of a road edge.

In some implementations, the camera system is a color type camera system that does not include an IR filter. In some implementations, the camera system is a color-IR type camera system where the CFA and a light sensor are associated with only a portion of a plurality of pixels and at least some of the plurality of pixels are associated with an IR sensor. In some implementations, the CFA is an RGB type CFA having red, green, and blue pixels associated with every three pixels of the plurality of pixels, and wherein the IR sensor is a passive IR sensor and every fourth pixel of the plurality of pixels are associated with the IR sensor and not the CFA. In some implementations, the IR assisted object segmentation and range perception method further comprises capturing, by a RADAR system of the vehicle, RADAR data of an environment external to the vehicle and receiving, by the control system and from the RADAR system, the RADAR data, wherein the generating of the environmental model further comprises (iii) fusing the range perception of the one or more objects based on the object segmentation with range perception based on the RADAR data.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1A is a functional block diagram of a vehicle having an example infrared (IR) assisted object segmentation and range perception system according to the principles of the present application;

FIG. 1B is a functional block diagram of an example color-IR camera system of the example IR assisted object segmentation and range perception system according to the principles of the present application;

FIG. 2 is a functional block diagram of an example system architecture for the IR assisted object segmentation and range perception system according to the principles of the present application;

FIGS. 3A-3C are examples of captured image data including unfiltered IR data, filtered color data, and other filtered data according to the principles of the present application; and

FIG. 4 is a flow diagram of an example IR assisted object segmentation and range perception method for a vehicle according to the principles of the present application.

### DESCRIPTION

As previously discussed, higher end vehicles utilize light detection and ranging (LIDAR) for precise range measurement, but LIDAR is very expensive. Camera-based depth or range perception is also prone to error as it is not a direct measurement. An alternative solution is to utilize radio detection and ranging (RADAR) for range detection. RADAR, however, is inherently noisy, particularly due to ground reflections. Fusion of camera and RADAR data is also difficult as it can be unclear which data point is correct. Accordingly, techniques that utilize infrared (IR) data (thermal contours) captured by a camera system as part of the object segmentation and range perception algorithms are presented herein. Conventionally, a camera system (e.g., a red/green/blue, or “RGB” color camera) includes a light sensor (photosensor) and a color filter array (CFA). In conventional applications, the IR data (thermal contours) captured by the light sensor are typically filtered and removed using a physical IR filter. Thus, any physical IR filter could be removed and digital IR filtering could be performed thereafter, or a RGB-IR type camera could be utilized. By utilizing this IR data, the performance of the object segmentation and range perception processes is increased without adding any additional sensors (e.g., LIDAR).

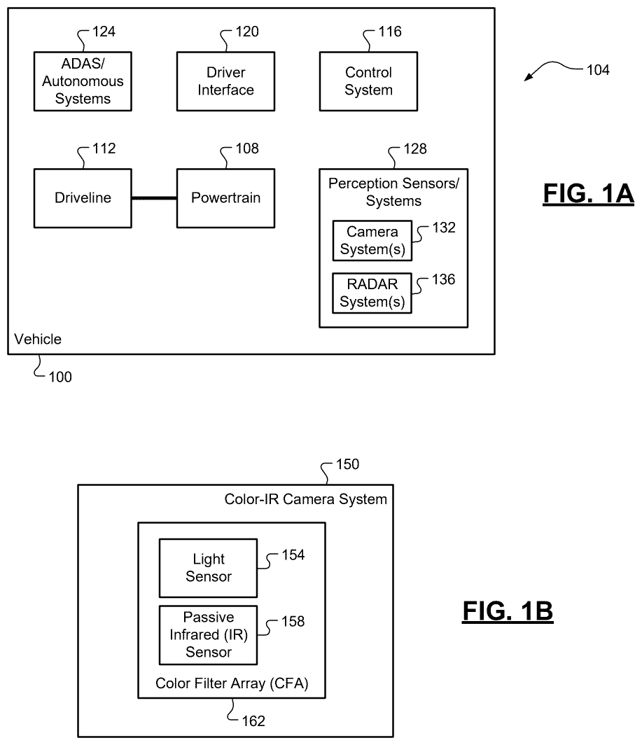

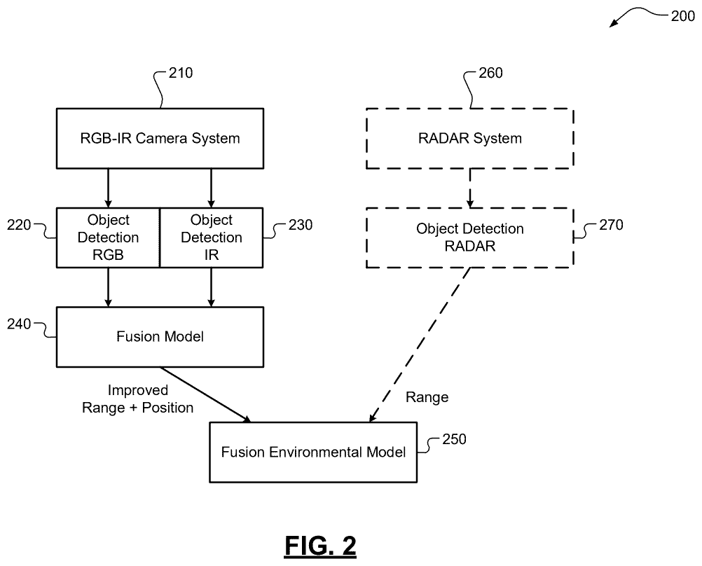

Referring now to FIG. 1A, a functional block diagram of a vehicle 100 having an example IR assisted object segmentation and range perception system 104 according to the principles of the present application is illustrated. The vehicle 100 generally comprises a powertrain 108 configured to generate and transfer drive torque to a driveline for propulsion. Non-limiting examples of components of the powertrain 108 include an electric motor, an internal combustion engine, a transmission, and combinations thereof. A controller or control system 116 controls operation of the vehicle 100, which primarily includes controlling the powertrain 108 to generate a sufficient amount of drive torque to satisfy a driver torque request provided by a driver of the vehicle 100 via a driver interface 120 (e.g., an accelerator pedal). The vehicle 100 also includes one or more automated driver-assistance (ADAS) or autonomous driving systems 124 that are each configured to execute one or more ADAS/autonomous driving features. Non-limiting examples of these ADAS/autonomous driving features include automated emergency braking (AEB), active cruise control (ACC), and automated lane keeping/changing. It will be appreciated that these are merely examples of ADAS/autonomous driving features and that the IR assisted object segmentation and range perception techniques of the present application could be applicable to any ADAS/autonomous (e.g., up to L4 or L5 fully-autonomous driving) or other driving features of the vehicle 100.

The control system 116 is also configured to generate an environmental model of an environment external to the vehicle 100. This environmental model can include detected objects and their corresponding distances or ranges. The generated environmental model can then be used by the control system 116 to control various aspects of operation of the vehicle 100, such as controlling acceleration/braking/steering of the vehicle 100 as part of the ADAS/autonomous driving features. The generation of this environmental model is performed based on data captured by various perception sensors or systems 128 of the vehicle 100. For the IR assisted object segmentation and range perception techniques of the present application, the perception sensors or systems 128 include one or more camera systems 132 and one or more optional RADAR sensors 136. As previously discussed herein, the IR assisted object segmentation and range perception techniques of the present application do not rely upon LIDAR based depth or range perception as LIDAR systems are very costly. Thus, the perception sensors or systems 128 likely do not include a LIDAR system configured for depth or range perception, although it will be appreciated that the vehicle 100 include a LIDAR system configured for a different use. The control system 116 is also configured to perform the IR assisted object segmentation and range perception techniques of the present application, which will now be discussed in greater detail.

Referring now to FIG. 1B and with continued reference to FIG. 1B, the camera system 132 of the vehicle 100 could have one of a plurality of different configurations. In one embodiment, the camera system 132 is a color type camera system that does not include an IR filter (e.g., a physical IR filter or a pre-processing digital IR filter). The color type camera generally comprises one or more light or photovoltaic sensors (e.g., one per pixel) configured to capture light data through a color filter array (CFA) resulting in filtered color data. The CFA could have any appropriate configuration, such as red/green/blue (RGB) type CFA (red/green/green/blue, or RGGB, red/yellow/yellow/cyan, or RYYCy, red/cyan/cyan/blue, or RCCB, etc.). These terms RGGB, RYYCy, and RCCB refer to the four pixels of a square 2×2 pixel CFA. In another embodiment, the camera system 132 is a color-IR type camera system 150 as shown in FIG. 1B. In this configuration, light or photovoltaic sensor(s) 154 capture light data that is passed through color filter portions (e.g., three of the four pixels) of a CFA 162, with the CFA 162 also defining a clear or pass-through pixel (e.g., every fourth pixel) where a passive IR sensor 158 provides unfiltered IR data (e.g., temperature or thermal gradients).

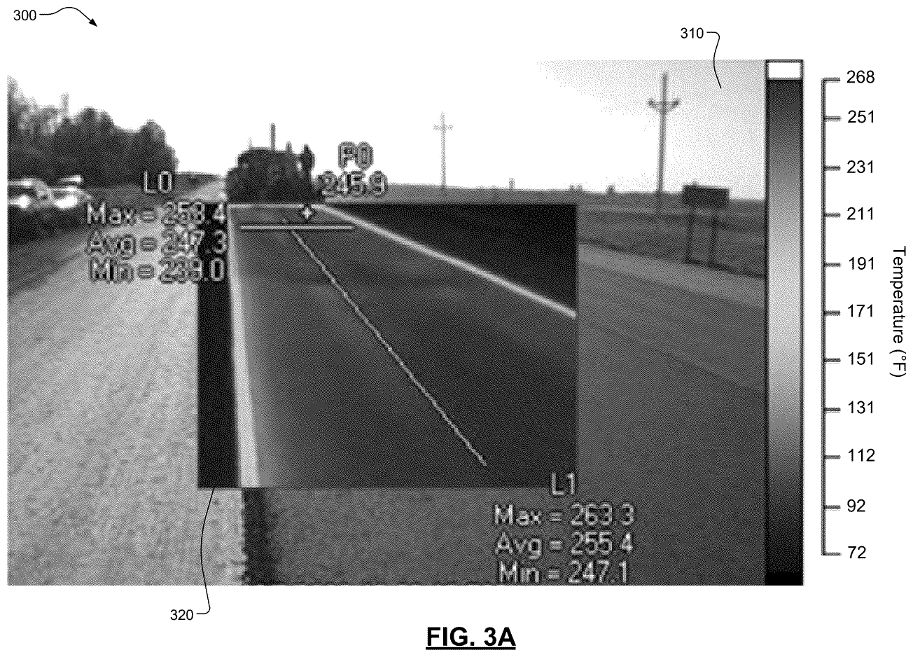

Referring now to FIG. 2 and with continued reference to FIGS. 1A-1B, a functional block diagram of an example system architecture 200 for the IR assisted object segmentation and range perception system 104 according to the principles of the present application is illustrated. As shown, the system architecture 200 moves from a conventional (and potentially faulty) color camera-based range perception with fusion of noisy RADAR data to an improved color and IR camera-based range perception with optional fusion of RADAR data. More specifically, an color-IR type (e.g., RGB-IR) camera system 210 (e.g., camera system 132) provides unfiltered IR data and filtered color data of captured image data and performs color-based object detection (e.g., RGB-based object detection) at 220 and IR-based object detection and 230. The outputs of these object detection processes are fused at 240 to achieve improved (i.e., more accurate) range perception, which is utilized to generate an improved fusion environmental model 250. As shown, a RADAR system 260 (e.g., RADAR system 136) could optionally be used to perform RADAR-based object detection 270 and the RADAR-based range perception could optionally be fused as part of a fusion environmental model 250. This is optional, however, as the fusion environmental model 250 could potentially be RADAR-less (i.e., not based on RADAR data), thereby potentially enabling RADAR-less solutions (e.g., for lower levels of vehicle autonomy).

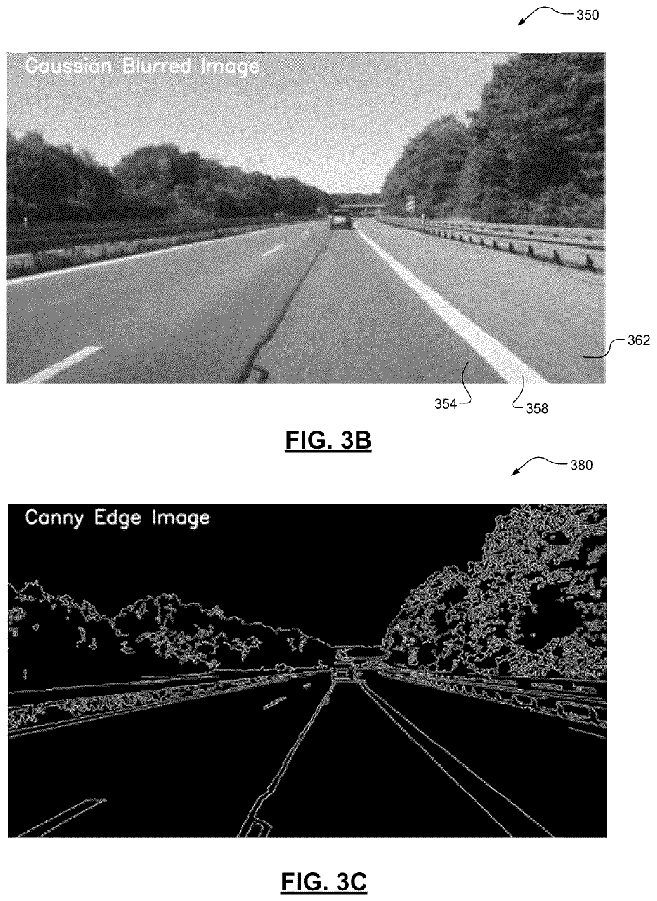

Referring now to FIGS. 3A-3C and with continued reference to the previous figures, examples of captured image data including unfiltered IR data 310, filtered color data 320, and other filtered data 350, 380 according to the principles of the present application are illustrated. In FIG. 3A, the captured image data 300 includes a plurality of pixels, some of which are filtered color pixels 310 (filtered color data) and some of which are unfiltered IR pixels 320 (unfiltered IR data). The addition of this thermal information 320, even what would be traditionally considered thermal noise, is achieved by removing the physical IR filter in a traditional RGB (RYYCy or RGGB, RCCB, etc.) or color type camera system or by leveraging an RGB-IR camera system with every fourth pixel being a passive IR sensor as previously shown and described. As shown in FIG. 3A, this, greatly improves luminance contrast as shown in the false color image 300. By comparing a gradient of a transform between the thermal image (or noise) and the RGB image, missing object information can be found, for example, the end of a lane with limited luminance contrast. This transform could be, for example, a Hough transform or based on the Hough transform method.

In FIGS. 3B-3C, we consider and illustrate a lane detection algorithm, but it will be appreciated that the same concept applies to a multitude of examples. Let us consider the Hough transform method and leverage open domain figures. In FIG. 3B, notice that to the left of or before (see 354) the lane marking 358 at an edge of a road, after a grayscale conversion and Gaussian blur, is roughly the same luminance as the road edge 362. In this case and as shown in FIG. 3B, the road edge is well marked by the white road edge marker 258. If we consider that this marking may not be available at this location, this would cause edge detection to fundamentally break, or the threshold of Canny edge detection as shown in the filtered image 380 of FIG. 3C would drive significant false edges into the system. This is a classic example of when rules based edge detection could fail. When edge detection and other rules based object segmentation and range perception systems fail, two-dimensional (2D) camera-based depth or range perception also fails. If objects can be segmented, and many objects have known or somewhat known relative sizes, an accurate depth or range profile can be derived by height in frame. If objects cannot be segmented, however, this is much more challenging. It is also important to note that this explanation uses classical computer vision techniques as an example. Modern ADAS/autonomous systems leverage mostly machine learning based approaches, but the problems states follow similar trends.

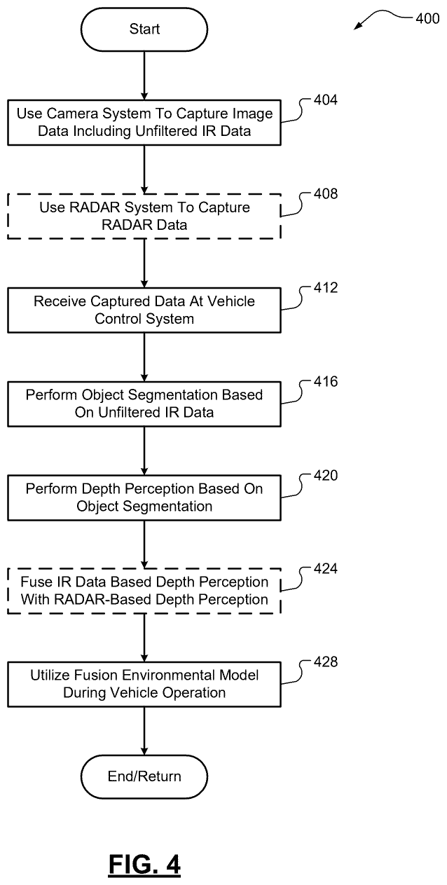

Referring now to FIG. 4 and with continued reference to the previous figures, a flow diagram of an example IR assisted object segmentation and range perception method 400 for a vehicle according to the principles of the present application is illustrated. While the method 400 specifically references the vehicle 100 and its components, it will be appreciated that the method 400 could be applicable to any suitably configured vehicle. The method 400 begins at 404 where the camera system 132 captures image data, including unfiltered IR data, of an environment external to the vehicle 100. At optional 408, the RADAR system 136 captures RADAR data of the environment. At 412, the control system 136 receives the captured image data and, if so desired or designed, the captured RADAR data. At 416, the control system 136 begins the generation of the environmental model by performing object segmentation based on the IR data as previously described herein. At 420, the control system 136 performs range perception based on the object segmentation and completes the generation of the environmental model. At optional 424, the control system 136 fuses the range perception based on the object segmentation using the unfiltered IR data with range perception based on the RADAR data and thereafter completes the generation of the environmental model. At 428, the control system 136 utilizes the generated environmental model during operation of the vehicle 100 (e.g., as part of the ADAS/autonomous driving features). The method 400 then ends.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An infrared (IR) assisted object segmentation and range perception system for a vehicle, the IR assisted object segmentation and range perception system comprising:
a camera system configured to capture image data of an environment external to the vehicle, the image data including unfiltered IR data; and
a control system configured to:
generate an environmental model for the environment external to the vehicle by:
(i) performing object segmentation of one or more objects in the captured image data based on the unfiltered IR data, and
(ii) based on the object segmentation, perform range perception of the one or more objects; and
utilize the generated environmental model during operation of the vehicle.

2. The IR assisted object segmentation and range perception system of claim 1, wherein the camera system is further configured to apply a color filter array (CFA) to at least a portion of the image data to obtain filtered color data that is part of the captured image data.

3. The IR assisted object segmentation and range perception system of claim 2, wherein the control system is configured to perform the object segmentation of the one or more objects based further on a combination of the unfiltered IR data and the filtered color data.

4. The IR assisted object segmentation and range perception system of claim 3, wherein the control system is further configured to:
determine a transform of the unfiltered IR data and the filtered color data;
based on a gradient of the determined transform, detect missing object segmentation data that is not present in the filtered color data; and
perform the object segmentation based on the detected missing object segmentation data.

5. The IR assisted object segmentation and range perception system of claim 4, wherein the transform is a Hough transform.

6. The IR assisted object segmentation and range perception system of claim 5, wherein the missing object segmentation data is a lane marking having a luminance that is substantially equal to a luminance of a road edge.

7. The IR assisted object segmentation and range perception system of claim 2, wherein the camera system is a color type camera system that does not include an IR filter.

8. The IR assisted object segmentation and range perception system of claim 2, wherein the camera system is a color-IR type camera system where the CFA and a light sensor are associated with only a portion of a plurality of pixels and at least some of the plurality of pixels are associated with an IR sensor.

9. The IR assisted object segmentation and range perception system of claim 8, wherein the CFA is a red/green/blue (RGB) type CFA having red, green, and blue pixels associated with every three pixels of the plurality of pixels, and wherein the IR sensor is a passive IR sensor and every fourth pixel of the plurality of pixels are associated with the IR sensor and not the CFA.

10. The IR assisted object segmentation and range perception system of claim 1, further comprising a radio detection and ranging (RADAR) system of the vehicle, wherein the RADAR system is configured to capture RADAR data of the environment external to the vehicle, and wherein the control system configured to generate the environmental model further by (iii) fusing the range perception of the one or more objects based on the object segmentation with range perception based on the RADAR data.

11. An infrared (IR) assisted object segmentation and range perception method for a vehicle, the IR assisted object segmentation and range perception method comprising:
capturing, by a camera system of the vehicle, image data of an environment external to the vehicle, the image data including unfiltered IR data;
receiving, by a control system of the vehicle and from the camera system, the RADAR data and the image data;
generating, by the control system, an environmental model for the environment external to the vehicle by:
(i) performing object segmentation of one or more objects in the captured image data based on the unfiltered IR data, and
(ii) based on the object segmentation, perform range perception of the one or more objects; and
utilizing, by the control system, the generated environmental model during operation of the vehicle.

12. The IR assisted object segmentation and range perception method of claim 11, further comprising applying, by the camera system, a color filter array (CFA) to at least a portion of the image data to obtain filtered color data that is part of the captured image data.

13. The IR assisted object segmentation and range perception method of claim 12, wherein the performing of the object segmentation of the one or more objects is based further on a combination of the unfiltered IR data and the filtered color data.

14. The IR assisted object segmentation and range perception method of claim 13, further comprising:
determining, by the control system, a transform of the unfiltered IR data and the filtered color data;
based on a gradient of the determined transform, detecting, by the control system, missing object segmentation data that is not present in the filtered color data; and
performing, by the control system, the object segmentation based on the detected missing object segmentation data.

15. The IR assisted object segmentation and range perception method of claim 14, wherein the transform is a Hough transform.

16. The IR assisted object segmentation and range perception method of claim 15, wherein the missing object segmentation data is a lane marking having a luminance that is substantially equal to a luminance of a road edge.

17. The IR assisted object segmentation and range perception method of claim 12, wherein the camera system is a color type camera system that does not include an IR filter.

18. The IR assisted object segmentation and range perception method of claim 12, wherein the camera system is a color-IR type camera system where the CFA and a light sensor are associated with only a portion of a plurality of pixels and at least some of the plurality of pixels are associated with an IR sensor.

19. The IR assisted object segmentation and range perception method of claim 18, wherein the CFA is a red/green/blue (RGB) type CFA having red, green, and blue pixels associated with every three pixels of the plurality of pixels, and wherein the IR sensor is a passive IR sensor and every fourth pixel of the plurality of pixels are associated with the IR sensor and not the CFA.

20. The IR assisted object segmentation and range perception method of claim 11, further comprising:
capturing, by a radio detection and ranging (RADAR) system of the vehicle, RADAR data of an environment external to the vehicle; and
receiving, by the control system and from the RADAR system, the RADAR data,
wherein the generating of the environmental model further comprises (iii) fusing the range perception of the one or more objects based on the object segmentation with range perception based on the RADAR data.
